(19) United States
(12) Patent Application Publication
(10) Pub. No.: US 2024/0098001 A1
(43) Pub. Date: Mar. 21, 2024

(54) DATA MANAGEMENT SYSTEM USING DOCKER SYSTEM IN EDGE COMPUTING ENVIRONMENT AND METHOD THEREOF

(71) Applicant: Kevinlab Co., Ansan-si (KR)

(72) Inventors: Kyung Hak KIM, Suwon-si (KR); Sung Hwan CHOI, Seoul (KR)

(73) Assignee: Kevinlab Co., Ansan-si (KR)

(21) Appl. No.: 18/465,673

(22) Filed: Sep. 12, 2023

(30) Foreign Application Priority Data
Sep. 20, 2022 (KR) 10-2022-0118734

(51) Int. Cl. H04L 43/065; H04L 43/04; H04L 67/1097

(52) U.S. Cl. CPC H04L 43/065; H04L 43/04; H04L 67/1097

(57) ABSTRACT

The present disclosure relates to a data management system and method and, more particularly, to a data management system and method using a docker system in an edge computing environment, the system and method collecting and managing data for each of control operation targets and each of characteristic of the control operation targets using a docker system in an edge computing-cloud computing linkage environment, and enabling an edge server to stably operate in accordance with the characteristics of the control operation targets even though communication between the edge server of an edge computing environment and a cloud server is impossible.

### STATEMENT REGARDING NATIONALLY SPONSORED RESEARCH OR DEVELOPMENT

This invention was made with government support by the Korea Energy Technology Evaluation and Planning (KETEP) on the basis of financial resource from the Ministry of Trade, Industry and Energy (MOTIE), Republic of Korea in 2022, under Project No. 1415180006. The Government has certain rights to the invention.

### CROSS REFERENCE TO RELATED APPLICATION

The present application claims priority to Korean Patent Application No. 10-2022-0118734, filed Sep. 20, 2022, the entire contents of which is incorporated herein for all purposes by this reference.

### BACKGROUND OF THE INVENTION

### Field of the Invention

The present disclosure relates to a data management system and method and, more particularly, to a data management system and method using a docker system in an edge computing environment, the system and method collecting and managing data for each of control operation targets and each of characteristic of the control operation targets using a docker system in an edge computing-cloud computing linkage environment, and enabling an edge server to stably operate in accordance with the characteristics of the control operation targets even though communication between the edge server of an edge computing environment and a cloud server is impossible.

### Description of the Related Art

With the development of smart devices and intelligent devices, the development of wired and wireless communication devices, etc., as the scale of data that are created in digital environments becomes massive, the creation cycle thereof is short, the formation thereof also becomes various such as a numerical value, a character, and a image, and the kind thereof is also varied such as location data, purchase data, visit record data, measurement data, condition data, and control data according to conditions, the necessity of collection and analysis of big data rises, and accordingly, technologies related to big data are rapidly increased.

Further, as it is determined that a cloud computing environment that sends and processes all of data, which are generated in devices such as a smart device and an intelligent device, in a cloud together with a big data is not realistic and efficient, edge computing that processes data at a place closest to the location where the data were created is rapidly increased.

However, an edge server for edge computing has limitation in processing big data and needs to be linked with a cloud server of a cloud computing environment.

Further, as the amount of data to be collected and analyzed increases, the load on an edge server and a cloud server increases, which increases power consumption.

Accordingly, it is required to develop a data management system that can efficiently perform collection and analysis of data through linkage of an edge server and a cloud server.

### SUMMARY OF THE INVENTION

Accordingly, an objective of the present disclosure is to provide a data management system and method using a docker system in an edge computing environment, the system and method collecting and managing data for each of control operation targets and each of characteristics of the control operation targets using a docker system in an edge computing-cloud computing linkage environment, and enabling an edge server to stably operate in accordance with the characteristics of the control operation targets even though communication between the edge server of an edge computing environment and a cloud server is impossible.

In order to achieve the objectives described above, a data management system using a docker system in an edge computing environment according to the present disclosure includes: an edge server unit that collects and analyzes data for each of control operations and performs corresponding calculation, includes many docker containers performing control operations corresponding to calculation and a docker execution table defining docker containers to be executed in accordance with operation condition information, collects and stores data by driving a docker container according to current operation condition information with reference to the docker execution table and then transmits calculation request information including the data and docker container information collecting the data, and receives cloud control information corresponding to the calculation request information and performs a corresponding control operation; and a cloud server that receives and stores the calculation request information, performs calculation corresponding to a docker container corresponding to the docker container information of the calculation request information by driving the docker container, and transmits cloud control information according to the calculation to the edge server unit.

The edge server unit includes: many information obtainers that collect data for control operations; and an edge server that drives a docker container corresponding to current operation condition information with reference to the docker execution table, collects and stores data through an information obtainer set in the driven docker container and then transmits calculation request information including the data and docker container information collecting the data, and receives cloud control information corresponding to the calculation request information and performs a corresponding control operation.

The edge server unit further includes at least one or more edge operation performers that perform operations corresponding to corresponding functions of the edge server unit, and the edge server includes: an edge storage unit including a docker container storage unit that stores the docker execution table and docker containers and a docker data storage unit that stores data collected for each of docker containers; an edge communication unit that enables data communication with the information obtainers and the cloud server through a wired/wireless data communication network; and an edge control unit that drives a docker container according to operation condition information with reference to the docker execution table, collects data obtained from an information obtainer set in a driven docker container through the edge communication unit and stores the data in the docker data storage unit, transmits calculation request information including the data and docker container information collecting the data to the cloud server through the edge communication unit, and receives cloud control information corresponding to the calculation request information from the cloud server and performs a control operation by controlling the corresponding edge operation performer.

The edge control unit includes: a driving docker container determiner that obtains operation condition information and determines a docker container, which corresponds to the operation condition information, as a docker container to be driven with reference to the docker execution table; a docker-based data collector that drives the determined docker container, collects data from an information obtainer set in the driven docker container through the edge communication unit, and stores the data in the docker data storage unit; an uploader that transmits calculation request information, which includes the data and docker container information collecting the data, to the cloud server through the edge communication unit; and an edge operation controller that receives cloud control information corresponding to the calculation request information from the cloud server and performs a control operation by controlling a corresponding edge operation performer.

The edge control unit further includes a docker container creator that provides a connecting means through the wired/wireless data communication network, provides a docker container creation means, which can create a docker container including a control application performing a corresponding control operation to a manager terminal connecting through the connecting means and can set operation condition information corresponding to the docker container, stores a created docker container in a docker container storage unit, and updates the docker execution table by adding docker container information of the docker container and operation condition information that is mapped to the docker container information to the docker execution table.

The edge control unit further includes a data deletion monitoring unit that detects and deletes data, of which a storage period exceeds a preset setting period of data uploaded to the cloud server and stored in the docker data storage unit, from the docker data storage unit.

The edge control unit includes: a downlink monitoring unit that monitors whether a downlink with the cloud server is normal; and an edge calculator that, when it is determined that there is a problem with the downlink with the cloud server through the downlink monitoring unit, drives a docker container corresponding to docker container information of calculation request information to be transmitted to the cloud server, creates control information by performing calculation by loading and applying data corresponding to itself by means of the driven docker container, and then provides the control information to the edge operation controller.

In order to achieve the objectives described above, a data management method using a docker system in an edge computing environment according to the present disclosure includes: a data upload process in which an edge server unit collects and stores data by driving a docker container according to current operation condition information with reference to a docker execution table stored in a docker container storage unit of an edge storage unit, and then transmits calculation request information including the data and docker container information collecting the data to a cloud server; a cloud control process in which the cloud server receives and stores the calculation request information, performs calculation corresponding to a docker container corresponding to the docker container information of the calculation request information by driving the docker container, and transmits cloud control information according to the calculation to the edge server unit; and a control operation performing process in which the edge server receives the cloud control information corresponding to the calculation request information and performs a corresponding control operation.

The data upload process includes: a driving docker container determination step in which an edge control unit of the edge server determines a docker container according to operation condition information with reference to the docker execution table through a driving docker container determiner; a docker-based data collection step in which the edge control unit drives the determined docker container through a docker-based data collector, collects data from an information obtainer set in the driven docker container through an edge communication unit, and stores the data in the docker data storage unit; and an upload step in which the edge control unit uploads calculation request information, which includes the data and docker container information collecting the data, to the cloud server through the edge communication unit, using an uploader.

The method further includes a docker container creation step in which the edge control unit provides a connecting means through a wired/wireless data communication network, provides a docker container creation means, which can create a docker container including a control application performing a corresponding control operation to a manager terminal connecting through the connecting means and can set operation condition information corresponding to the docker container, stores a created docker container in a docker container storage unit, and updates the docker execution table by adding docker container information of the docker container and operation condition information that is mapped to the docker container information to the docker execution table, through a docker container creator.

The method further includes a data deletion monitoring process in which the edge control unit detects and deletes data, of which a storage period exceeds a preset setting period of data stored in the docker data storage unit and uploaded to the cloud server, from the docker data storage unit, through a data deletion monitoring unit.

The method further includes: a downlink monitoring process in which the edge control unit monitors whether a downlink with the cloud server is normal through a downlink monitoring unit; and an edge calculation process in which when it is determined that there is a problem with the downlink with the cloud server through the downlink monitoring unit, the edge control unit drives a docker container corresponding to docker container information of calculation request information to be transmitted to the cloud server through an edge calculator, creates control information by applying data corresponding to the driven docker container to calculation corresponding to the docker container, and provides the control information to an edge operation controller.

According to the present disclosure, since an edge server and a cloud server operate by driving only a docker container that collects and processes information according to operation condition information, and collect and transmit only information corresponding to a control operation target corresponding to operation condition information, it is not required to perform unnecessary data collection and analysis and an unnecessary calculation operation, so there is an effect that it is possible to minimize load on a system and reduce power consumption.

Further, according to the present disclosure, since calculate for operation of the edge server is performed at the cloud server, there is an effect that it is possible to reduce load on the edge server and reduce power consumption.

Further, according to the present disclosure, since the edge server stores data uploaded in the cloud server only for a predetermined period and then deletes the data, there is an effect that it is possible to keep a system light by optimizing the amount of data stored in the edge server.

Further, according to the present disclosure, since when communication with the cloud server that performs a calculation operation is impossible, the edge server performs a calculation operation by itself using its own data and performs a corresponding operation, operations depending on a communication state is not influenced, so there is an effect that it is possible to stably perform operations.

### BRIEF DESCRIPTION OF THE DRAWINGS

FIG. 1 is a view showing the configuration of a data management system using a docker system in an edge computing environment according to the present disclosure;

FIG. 2 is a view showing the configuration of an edge server of the data management system according to the present disclosure; and

FIG. 3 is a flowchart showing a data management method using a docker system in an edge computing environment according to the present disclosure.

### DETAILED DESCRIPTION OF THE INVENTION

Hereafter, the configuration and operation of a data management system using a docker system in an edge computing environment according to the present disclosure is described in detail and then a data management method in the system is described with reference to the accompanying drawings.

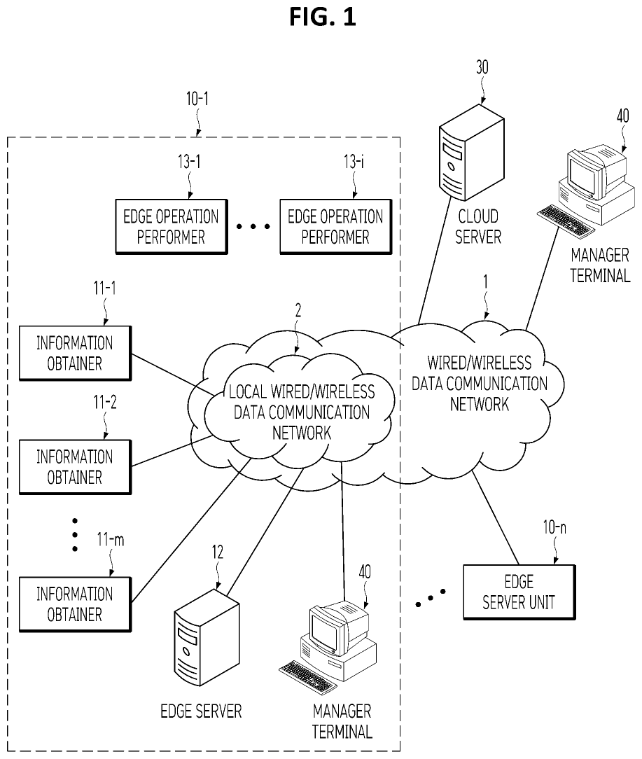

FIG. 1 is a view showing the configuration of a data management system using a docker system in an edge computing environment according to the present disclosure.

A data management system using a docker system in an edge computing environment according to the present disclosure includes at least one or more edge server units 10 and a cloud server 30, and, depending on embodiments, may further include a manager terminal unit 40.

The edge server units 10 and the cloud server 30 are connected to a wired/wireless communication network 1 in any one of wired and wireless types, and perform data communication therebetween.

The wired/wireless communication network 1 may be an internet network including a Zigbee wireless network, WiFi, and a local area network (LAN), and may be a data communication network combined with any one or more of mobile communication networks such as 3 Generation (3G), 4G, and 5G.

The edge server unit 10 includes at least one or more information obtainers 11, an edge server 12, and at least one or more edge operation performers 13.

The information obtainer 11 may be configured to perform data communication with the edge server 12 and the manager terminal unit 40 through a local wired/wireless data communication network 2, which includes any one or more of an internet network including the Zigbee wireless network, WiFi, and local area network of the wired/wireless communication network 1 and provides data communication in a specific local area, or may be configured to be connected to a mobile communication network that is not the local wired/wireless communication network 2 connected with the edge server 12, that is, another local wired/wireless communication network 2 and to perform data communication with the edge server 12 and the manager terminal 40.

Further, the information obtainer 11 may be connected directly to the edge serve 12 in wireless and wired types and may perform data communication.

The information obtainer 11 is installed in an information collection area and collects and transmits information about the information collection area to the edge server 12. The information collection area may be an area including the outer wall of a building or a certain location in a building, and may be a specific part of a device. For example, the information obtainer 11 may be a temperature measurement device, a humidity measurement device, etc. that measure the temperature, humidity, etc. of the outer wall of a building, may be an interior temperature measurement device, an interior humidity measurement device, an illuminance measurement device, etc. that measure the interior temperature, humidity, illuminance, etc. of a building, may be an information provision device that obtains and provides temperature, humidity, etc. information that is controlled in cooling and heating, and may be a joint angle tracing device, etc. that trace a joint bending angle of a robot arm, etc.

The edge operation performer 13 is controlled by the edge server 12, thereby performing operations corresponding to corresponding functions of the edge server 12. The operation may be a cooling control operation, a heating control operation, a robot arm control operation, a power control operation, an air conditioner control operation, etc., and the edge operation performer 140 may be a cooler that adjusts the temperature of an interior, a heater, an air conditioner, a robot arm, a power controller, etc.

The edge server 2, which is a server that performs corresponding operation in real time at an end, that is, an edge of a network, may be a wall pad that is installed in a certain area of a building and controls temperature, illuminance, air conditioning, etc. in the area, a robot arm controller that performs control of a robot arm in a production line of a factory, etc.

The edge server 12 according to the present disclosure collects and analyzes data for each of control operations corresponding to installed operation target areas and performs corresponding calculation, and includes many docker containers that perform corresponding control operations corresponding to calculation by controlling the edge operation performer 13, and a docker execution table that defines docker containers to be executed in accordance with operation condition information. The operation condition information, which is condition information for performing control operations that are performed by docker containers, may be a date, a period, temperature, humidity, an angle, etc. For example, operation condition information may be information about the period of the summer (June˜September), and a docker container that collects the temperature of an outer wall and the temperature of an interior and performs cooling control may be applied to the period.

The edge server 12 collects and stores data by driving a docker container according to the current operation condition information with reference to the docker execution table and then transmits calculation request information, which includes the data, docker container information collecting the data, and edge server identification information, to the cloud server 30, and receives cloud control information corresponding to the calculation request information from the cloud server 30, and performs a control operation of controlling a corresponding edge operation performer 13.

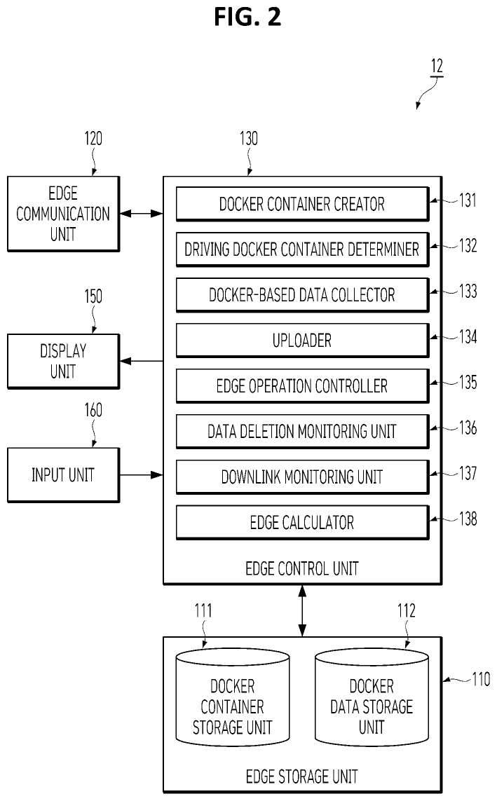

The detailed configuration and detailed operation of the edge server 12 are described below with reference to FIG. 2.

The cloud server 30 stores and manages data collected through all of the dock containers, which the many edge servers 12 have, and a corresponding docker container

When receiving calculation request information from an edge server 12, the cloud server 30 execution a docker container corresponding to docker container information of the calculation request information, performs a corresponding calculation operation by applying data included in the cloud calculation request information to the docker container, and transmits cloud control information including control information corresponding to the calculation operation to the edge server 12.

The cloud server 30 executes a corresponding docker container, calls for only corresponding data through the executed docker container, and performs calculation, so it is not required to perform unnecessary operations due to unnecessary data search, analysis, etc., whereby it is possible to reduce the calculation time and it would be possible to decrease system power consumption.

Further, any one or more of the edge server 12 and the cloud server 30 may be configured to provide a connection means for a web server-based web page or an app server-based app page that the manager terminal 40 can connect with, to provide a docker container creation means to the manager terminal 40 connected through the connection means, to create a docker container through the docker container creation means, and to receive and store operation condition information about the docker container in a storage unit, and may be configured to transmit the created docker container and the operation condition information to a counter server (the cloud server 30 when it is created at the edge server 12 and the edge server 12 when it is created at the cloud server 30).

The manager terminal 40 may be a computer terminal such as a desk top, a person computer, a lap top, or may be a mobile terminal such as a smart phone and a smart pad.

The manager terminal 40 is connected to the wired/wireless data communication network 1 or the local wired/wireless data communication network 2, connects with the edge server 12 or the cloud server 30, is provided with a docker container creating means provided from the edge server 12 or the cloud server 30, and enables a manager to create a docker container through the docker container creation means.

FIG. 2 is a view showing the configuration of an edge server of the data management system according to the present disclosure.

Referring to FIG. 2, the edge server 12 includes an edge storage unit 110, an edge communication unit 120, and an edge control unit 130, and, depending on embodiments, may further include a display unit 150 and an input unit 170.

The edge storage unit 110 includes a program area that stores a control program for controlling the general operation of the edge server 12 according to the present disclosure, a temporal area that temporarily stores data generated while the control program is executed, and a data area that semi-permanently stores data required for executing the control program and data generated while the control program is executed.

A docker container storage unit 111 and a docker data storage unit 112 may be configured in the data area in accordance with the present disclosure.

The docker container storage unit 111 stores many docker containers that perform a control operation corresponding to calculation by applying preset data, and a docker execution table that define docker containers to be executed in accordance with operation condition information. The docker container would include setting information, which includes information about at least one or more information obtainers 11 to collect data and information about the edge operation performer 13 to be controlled, and an application for collecting data from the information obtainers 11 of the setting information, performing calculation, and controlling the edge operation performer 13.

The docker data storage unit 112 maps and stores docker container information and data collected by a docker container of the docker container information. That is, the docker data storage unit 112 stores data collected for each docker container.

The edge communication unit 120 connects with a mobile communication network of the local wired/wireless data communication network 2 or the wired/wireless data communication network 1 in any one of wired and wireless types so that data communication can be performed with other devices connecting with the wired/wireless data communication network 1 and the local wired/wireless data communication network 2.

The edge communication unit 120 may further include a local area wireless communication means and a local area wired communication means that are connected with the information obtainer 11 and the edge operation performer 13 directly in any one of wired and wireless types and perform data communication. The local area wireless communication means may be Bluetooth, WiFi Direct, Ultra Wide Band (UWB), etc., and the local area wired communication means may be IEEE1394, a USB, etc.

The display unit 150 may be a Liquid Crystal Display (LCD), an organic EL display, etc., and is controlled by the edge control unit 130 to display the operation state of the edge server 12, information that is input, etc.

The input unit 160 may include any one or more of a button input device having many buttons for function control, function setting, etc., a touch pad integrated with the screen of the display unit 150 and outputting a position signal corresponding to a touched position, etc.

The edge control unit 130 includes a driving docker container determiner 132, a docker-based data collector 133, an uploader 134, and an edge operation controller 135, and, depending on embodiments, further includes a docker container creator 131, a data deletion monitoring unit 136, a downlink monitoring unit 137, and an edge calculator 138, and controls general operation of the edge server 12 according to the present disclosure.

In detail, the docker container creator 131 provides a connecting means through the wired/wireless data communication network 1 and provides a docker container creation means that can create a docker container that includes a control application performing a corresponding control operation to a manager terminal 40 connecting through the connecting means, setting information of the information obtainer 11 to collect data and the edge operation performer 13 to be controlled, etc., and can set operation condition information corresponding to the docker container.

The docker container creator 131 stores the created docker container in the docker container storage unit 111 and updates the docker execution table stored in the docker container storage unit 111 by adding docker container information of the docker container and operation condition information that is mapped to the docker container information to the docker execution table.

The docker container creator 131 may be configured to download a created docker container, which corresponds to a corresponding edge server unit 10, and operation condition information from the cloud server 30 through the edge communication unit 120, to store the docker container and operation condition information in the docker container storage unit 111, and to update a docker execution table by adding the docker container and operation condition information.

The driving docker container determiner 132 obtains operation condition information and determines a docker container, which corresponds to the operation condition information, as a docker container to be driven with reference to the docker execution table. The operation condition information may be obtained from a system timer (not shown) and may be obtained from one or more preset information obtainers 11 of information obtainers 11.

The docker-based data collector 133 drives the determined docker container, collects data from one or more information obtainers 11 set in the driven docker container through the edge communication unit 120, and stores the data in the docker data storage unit 112.

The uploader 134 transmits calculation request information, which includes the data and docker container information collecting the data, to the cloud server through the edge communication unit. The calculation request information may further include edge server identification information of the edge server 12.

The edge operation controller 135 receives cloud control information corresponding to the calculation request information from the cloud server 30 and performs a corresponding control operation by controlling the edge operation performer 13 corresponding to the cloud control information.

Further, the edge operation controller 135 performs a corresponding control operation by controlling the edge operation performer 13 corresponding to control information that is input from the edge calculator 138.

The data deletion monitoring unit 136 detects and deletes data, of which the storage period exceeds a preset setting period of the data uploaded from the cloud server 30 and stored in the docker data storage unit 112, from the docker data storage unit 112.

The downlink monitoring unit 137 monitors whether the downlink with the cloud server 30 is normal. Whether the downlink is normal may be determined by examining whether cloud control information is received in accordance with transmission of control request information or by transmitting a certain Null signal requesting a response and examining whether a corresponding response is received.

When it is determined that there is a problem with the downlink with the cloud server 30 through the downlink monitoring unit 137, the edge calculator 138 drives a docker container corresponding to docker container information of calculation request information to be transmitted to the cloud server 30.

The driven docker container creates control information by loading and applying corresponding data, which corresponds to setting thereof, and performing calculation, and then provides the control information to the edge operation controller 135.

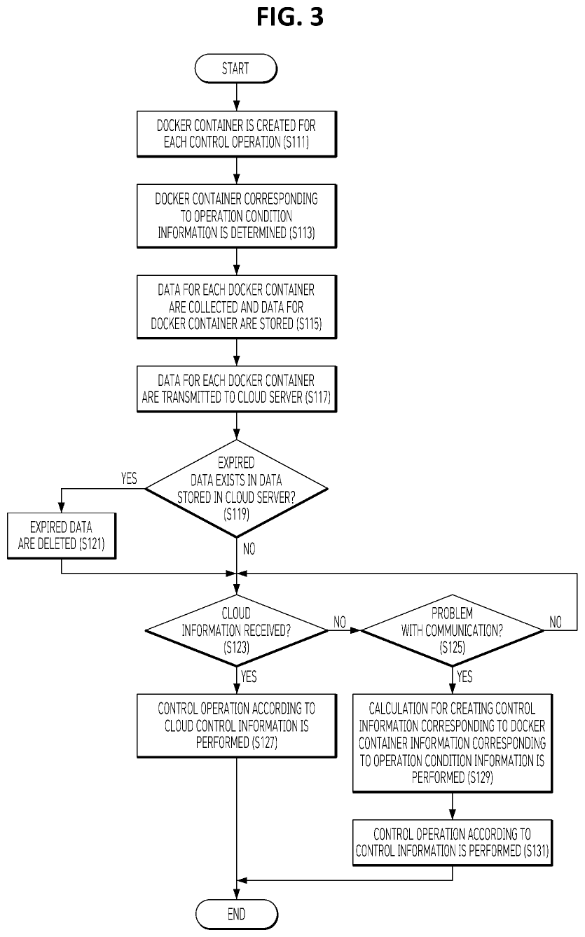

FIG. 3 is a flowchart showing a data management method using a docker system in an edge computing environment according to the present disclosure.

Referring to FIG. 3, the edge control unit 130 of the edge server 12 creates at least one or more docker containers corresponding to an operation target area and operation condition information corresponding to each of the docker containers through the docker container creator 131 or downloads the docker containers and operation condition information from the cloud server 30, stores the docker containers and operation condition information in the docker container storage unit 111, and updates a docker execution table (S111).

When an operation execution event is generated, the edge control unit 130 obtains operation condition information, and finds and determines at least one or more docker containers, which correspond to the operation condition information, as driven docker containers with reference to the docker execution table. The operation execution event may be generated at predetermined periods, may be generated when there is an operation request through the input unit 160 by a user, a manager, etc., and may be generated when a preset condition (e.g., timer setting, etc.) is satisfied.

When a docker container to be driven is determined, the edge control unit 130 drives the docker container. The driven docker container collects data from one or more information obtainers 11 set in the docker container and stores the data in the docker data storage unit 110.

When data are collected by the docker container, the edge control unit 130 transmits control request information including the collected data to the cloud server 30 (S117).

After transmitting the control request information, the edge control unit 130 checks whether there are data of which the storage period exceeds a preset setting period of the data transmitted to the cloud server 3 and stored in the docker data storage unit 112.

When there are data of which the storage period exceeds the setting period, the edge control unit 130 deletes the data from the docker data storage unit 112 (S121).

When there is no data of which the storage period exceeds the setting period or after deleting such data, the edge control unit 130 determines whether cloud control information is received from the cloud server 30 (S123) and whether there is a problem with communication with the cloud server 30 (S125).

When the cloud control information is received, the edge control unit 130 performs a corresponding control operation by controlling the edge operation performer 13 corresponding to the cloud control information (S127).

However, when cloud control information is not received and it is determined that there is a problem with communication with the cloud server 30, the edge control unit 130 performs a calculation operation by itself by applying corresponding data to the driven docker container corresponding to the operation condition information, and creates control information according to the calculation operation (S129).

When self-control information is created, the edge control unit 13 performs a corresponding control operation by controlling the edge operation performer 13 corresponding to the control information (S131).

Meanwhile, those skilled in the art would easily understand that the present disclosure is not limited only to the typical preferred embodiments described above and may be achieved through improvement, modification, replacement, or addition in various ways without departing from the scope of the present disclosure. When achievement by such improvement, modification, replacement, or addition is included in the range of claims, the spirit thereof should also be considered as being included in the present disclosure.

What is claimed is:

1. A data management system using a docker system in an edge computing environment, the data management system comprising:
an edge server unit that collects and analyzes data for each of control operations and performs corresponding calculation, includes many docker containers performing control operations corresponding to calculation and a docker execution table defining docker containers to be executed in accordance with operation condition information, collects and stores data by driving a docker container according to current operation condition information with reference to the docker execution table and then transmits calculation request information including the data and docker container information collecting the data, and receives cloud control information corresponding to the calculation request information and performs a corresponding control operation; and
a cloud server that receives and stores the calculation request information, performs calculation corresponding to a docker container corresponding to the docker container information of the calculation request information by driving the docker container, and transmits cloud control information according to the calculation to the edge server unit.

2. The data management system of claim 1, wherein the edge server unit includes:
many information obtainers that collect data for control operations; and
an edge server that drives a docker container corresponding to current operation condition information with reference to the docker execution table, collects and stores data through an information obtainer set in the driven docker container and then transmits calculation request information including the data and docker container information collecting the data, and receives cloud control information corresponding to the calculation request information and performs a corresponding control operation.

3. The data management system of claim 2, wherein the edge server unit further includes at least one or more edge operation performers that perform operations corresponding to corresponding functions of the edge server unit, and
the edge server includes:
an edge storage unit including a docker container storage unit that stores the docker execution table and docker containers and a docker data storage unit that stores data collected for each of docker containers;
an edge communication unit that enables data communication with the information obtainers and the cloud server through a wired/wireless data communication network; and
an edge control unit that drives a docker container according to operation condition information with reference to the docker execution table, collects data obtained from an information obtainer set in a driven docker container through the edge communication unit and stores the data in the docker data storage unit, transmits calculation request information including the data and docker container information collecting the data to the cloud server through the edge communication unit, and receives cloud control information corresponding to the calculation request information from the cloud server and performs a control operation by controlling the corresponding edge operation performer.

4. The data management system of claim 3, wherein the edge control unit includes:
a driving docker container determiner that obtains operation condition information and determines a docker container, which corresponds to the operation condition information, as a docker container to be driven with reference to the docker execution table;
a docker-based data collector that drives the determined docker container, collects data from an information obtainer set in the driven docker container through the edge communication unit, and stores the data in the docker data storage unit;
an uploader that transmits calculation request information, which includes the data and docker container information collecting the data, to the cloud server through the edge communication unit; and
an edge operation controller that receives cloud control information corresponding to the calculation request information from the cloud server and performs a control operation by controlling a corresponding edge operation performer.

5. The data management system of claim 4, wherein the edge control unit further includes a docker container creator that provides a connecting means through the wired/wireless data communication network, provides a docker container creation means, which can create a docker container including a control application performing a corresponding control operation to a manager terminal connecting through the connecting means and can set operation condition information corresponding to the docker container, stores a created docker container in a docker container storage unit, and updates the docker execution table by adding docker container information of the docker container and operation condition information that is mapped to the docker container information to the docker execution table.

6. The data management system of claim 4, wherein the edge control unit further includes a data deletion monitoring unit that detects and deletes data, of which a storage period exceeds a preset setting period of data uploaded to the cloud server and stored in the docker data storage unit, from the docker data storage unit.

7. The data management system of claim 4, wherein the edge control unit includes:
a downlink monitoring unit that monitors whether a downlink with the cloud server is normal; and
an edge calculator that, when it is determined that there is a problem with the downlink with the cloud server through the downlink monitoring unit, drives a docker container corresponding to docker container information of calculation request information to be transmitted to the cloud server, creates control information by performing calculation by loading and applying data corresponding to itself by means of the driven docker container, and then provides the control information to the edge operation controller.

8. A data management method using a docker system in an edge computing environment, the data management method comprising:
a data upload process in which an edge server unit collects and stores data by driving a docker container according to current operation condition information with reference to a docker execution table stored in a docker container storage unit of an edge storage unit, and then transmits calculation request information including the data and docker container information collecting the data to a cloud server;
a cloud control process in which the cloud server receives and stores the calculation request information, performs calculation corresponding to a docker container corresponding to the docker container information of the calculation request information by driving the docker container, and transmits cloud control information according to the calculation to the edge server unit; and
a control operation performing process in which the edge server receives the cloud control information corresponding to the calculation request information and performs a corresponding control operation.

9. The data management method of claim 8, wherein the data upload process includes:
a driving docker container determination step in which an edge control unit of the edge server determines a docker container according to operation condition information with reference to the docker execution table through a driving docker container determiner;
a docker-based data collection step in which the edge control unit drives the determined docker container through a docker-based data collector, collects data from an information obtainer set in the driven docker container through an edge communication unit, and stores the data in a docker data storage unit; and
an upload step in which the edge control unit uploads calculation request information, which includes the data and docker container information collecting the data, to the cloud server through the edge communication unit, using an uploader.

10. The data management method of claim 9, further comprising a docker container creation step in which the edge control unit provides a connecting means through a wired/wireless data communication network, provides a docker container creation means, which can create a docker container including a control application performing a corresponding control operation to a manager terminal connecting through the connecting means and can set operation condition information corresponding to the docker container, stores a created docker container in a docker container storage unit, and updates the docker execution table by adding docker container information of the docker container and operation condition information that is mapped to the docker container information to the docker execution table, through a docker container creator.

11. The data management method of claim 9, further comprising a data deletion monitoring process in which the edge control unit detects and deletes data, of which a storage period exceeds a preset setting period of data stored in the docker data storage unit and uploaded to the cloud server, from the docker data storage unit, through a data deletion monitoring unit.

12. The data management method of claim 9, further comprising:
a downlink monitoring process in which the edge control unit monitors whether a downlink with the cloud server is normal through a downlink monitoring unit; and
an edge calculation process in which when it is determined that there is a problem with the downlink with the cloud server through the downlink monitoring unit, the edge control unit drives a docker container corresponding to docker container information of calculation request information to be transmitted to the cloud server through an edge calculator, creates control information by applying data corresponding to the driven docker container to calculation corresponding to the docker container, and provides the control information to an edge operation controller.
